(19) United States
(12) Patent Application Publication
(10) Pub. No.: US 2006/0217114 A1
(43) Pub. Date: Sep. 28, 2006

(54) Customer service module

(75) Inventor: Chung-Hsin Chen, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/088,823

(22) Filed: Mar. 25, 2005

(51) Int. Cl. H04Q 7/20

(52) U.S. Cl. 455/423

(57) ABSTRACT

A customer service module used to handle a service for maintenance and repair of a wireless communication device requested by a customer is disclosed. The customer service module comprises a database storing at least a set of status information comprising a set of failure status information and a set of maintenance and repair status information and corresponding to an identification serial number of the wireless communication device. A failure information inputting interface at a service terminal is used to input the set of failure status information and a maintenance and repair status inputting interface at a maintenance and repair terminal is used to input the set of maintenance and repair status information. A status displaying interface is located at the service terminal and the maintenance and repair terminal respectively and used to display the set of failure status information or the set of maintenance and repair information according to the identification serial number.

### BACKGROUND OF THE INVENTION

1. Field of Invention

The present invention relates to a customer service module and particularly to a customer service module handling a service for maintenance and repair of a wireless communication device requested by a customer.

2. Related Art

Referring to FIG. 1, a prior customer service module is schematically illustrated therein. The prior customer service module 2 is used to handle a service for maintenance and repair of a wireless communication device.

The prior customer service module comprises a customer service terminal 6 and a maintenance and repair terminal 8. When a service for maintenance and repair of a wireless communication device is requested from a customer, a serviceman at the service terminal 6 will query roughly the customer about his basic information and a reason why the wireless communication device is required to be maintained and repaired. Next, the information obtained from the customer is recorded in a maintenance and repair fact sheet and the maintenance and repair fact sheet is then passed to a maintenance and repair terminal 8 of the customer service module 2 along with the wireless communication device requested to be maintained and repaired. When the wireless communication device is done with a maintenance and repair process, the maintenance and repair terminal 8 delivers it back to the service terminal 6 of the customer service module 2.

Generally, when a maintenance staff at the maintenance and repair terminal 8 receives the maintenance and repair fact sheet, he will maintain and repair the wireless communication device according to the reason recorded in the maintenance and repair fact sheet. However, the maintenance and repair fact sheet may have chances of being lost or rashly recorded without clear and definite recitation about the reason of failure. In addition, since the maintenance and repair fact sheet is not electronically recorded, further query of the reason in the maintenance and repair fact sheet may not be made by the maintenance staff in a more systematized manner. Accordingly, the maintenance staff may need more efforts and time to understand the actual reason of failure or even be not able to fully capture the meaning of the recited reason of failure.

Furthermore, when the customer queries, if made, the status of maintenance and repair of the wireless communication device during the time it is under the maintain and repair process, the serviceman at the service terminal 6 may have chances of not wholly realizing the current status about the wireless communication device and cannot give the customer with a clear response immediately, which generally incurs complaints about the service quality provided.

Therefore, there is a need to set forth a customer service module which may avoid the above disadvantages.

### SUMMARY OF THE INVENTION

It is, therefore, an object to provide a customer service module handling a service for maintenance and repair of a wireless communication device requested from a customer, which provides a status displaying interface at a maintenance and repair terminal thereof for displaying a reason of failure of the wireless communication device supposed to be failed and the status displaying interface at a service terminal thereof for displaying a status about maintenance and repair of the wireless communication device.

To achieve the above object, the customer service module comprises a server, a service terminal and a maintenance and repair terminal, in which the server is coupled to the service terminal and the maintenance and repair terminal through a network. The customer service module further comprises a database, a failure information inputting interface, a maintenance and repair status inputting interface and a status displaying interface. The database is contained in the server, the failure information inputting interface and the status displaying interface are contained in the service terminal and the maintenance and repair status inputting interface and the status displaying interface are contained in the maintenance and repair terminal.

A set of status information comprises a set of failure status information and a set of maintenance and repair status information and corresponds to an identification serial number of the wireless communication device supposed to be failed. The set of status information is stored in the database though an input to the customer service module. As the identification serial number, at least a product serial number or IMEI (International Mobile Equipment Identifier) codes of the wireless communication device may be used.

Each set of failure status information and maintenance or repair status information are inputted using its identification serial number as its latest status.

According to the inputted identification serial number, the set of status information comprising the failure information and the maintenance and repair information is located

In the customer service module, the failure information inputting interface and the maintenance and repair status inputting interface may be a keyboard respectively or a mouse and a pull-down menu module respectively.

With the customer service module, the maintenance staff may adequately understand the reason of maintenance and repair requested given at the service terminal 36 with respect to the wireless communication device through the status displaying interface 44b at the maintenance and repair terminal 36 and the service staff may fully realize the current status of maintenance and repair of the wireless communication device through the status display interface 44a at the service terminal 34. Therefore, the service quality of maintenance and repair is promoted.

The further advantages and principles of the present invention may be best understood after the following description of the preferred embodiments thereof are read with reference to the accompanying drawings.

### BRIEF DESCRIPTION OF THE DRAWINGS

The invention will become more fully understood from the detailed description given hereinbelow illustration only, and thus are not limitative of the present invention, and wherein:

FIG. 1 is a schematic diagram of a prior customer service module;

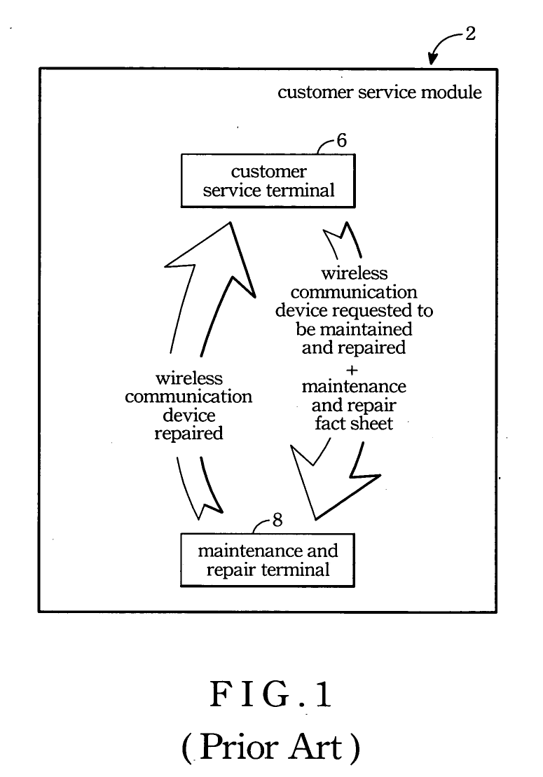

FIG. 2 is a schematic diagram of a customer service module according to the present invention; and

FIG. 3 is a schematic diagram of an inputting interface of the customer service module according to the present invention.

### DETAILED DESCRIPTION OF THE INVENTION

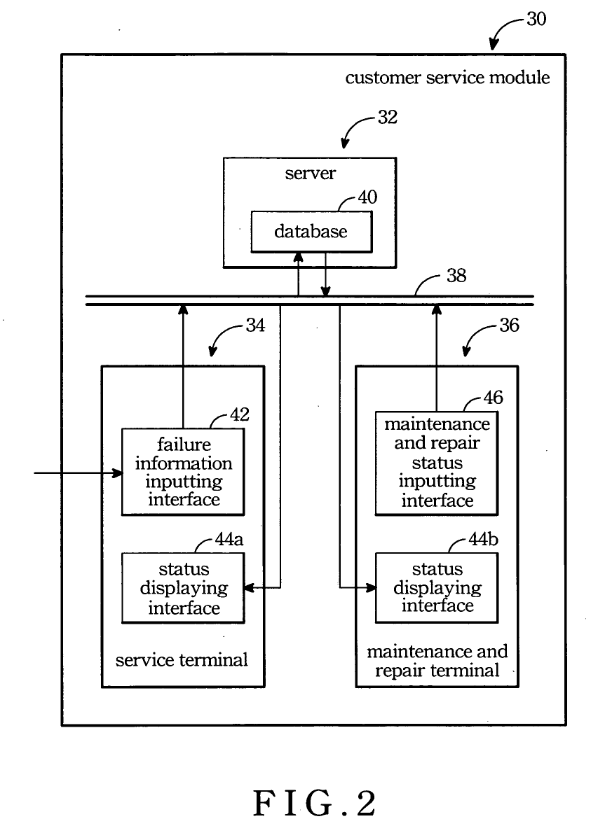

Referring to FIG. 2, a schematic diagram of a customer service module according to the present invention is illustrated therein. The customer service module 30 comprises a server 32, a service terminal 34 and a maintenance and repair terminal 36 coupled to one another through a network 38.

A database 40 is included in the server 32 and used to store at least a set of status information. The set of status information comprises a set of failure status information and a set of maintenance and repair status information and corresponds to an identification serial number of a wireless communication device requested to be maintained and repaired by a customer. The identification serial number may be, for instances, a product serial number or IMEI (International Mobile Equipment Identifier) codes of the wireless communication device.

In the service terminal 34, there comprise a failure information inputting interface 42 and a status displaying interface 44a. When the service terminal 34 is requested with the service of maintenance and repair of the wireless communication device from the customer, a service staff queries a reason of failure of the wireless communication device from the customer and then inputs the reason and the identification number corresponding thereto as a reference number to the database 40 through the failure information inputting interface 42. According to the reference number, the status displaying interface 44a displays a set of status information with respect to the wireless communication device, and particularly a set of maintenance and repair status information. The generation of the set of maintenance and repair status information will be described as follows.

In the maintenance and repair terminal 36, there include a status displaying interface 44b and a maintenance and repair status inputting interface 46. According to the identification number of the wireless communication device, the status displaying interface 44b displays a set of status information of the wireless communication device, particularly a set of failure status information. With the set of failure status information, a maintenance staff at the maintenance and repair terminal 36 may perform a maintenance and repair task over the wireless communication device. During the maintenance and repair process, the maintenance staff may input the latest set of maintenance and repair status information through the maintenance and repair inputting interface 46, and the service terminal 34 may obtain the set of maintenance and repair status information through the status displaying interface 44a using the reference number.

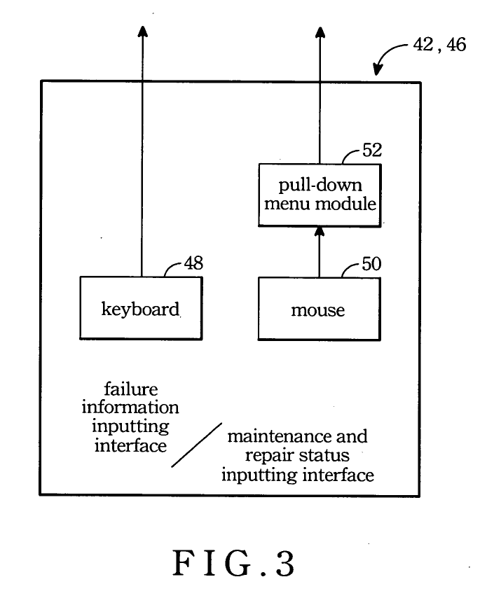

Referring to FIG. 3, an input interface of the customer service module according to the present invention is illustrated therein. The input interface may refer to either of the failure information inputting interface 42 and the maintenance and repair status inputting interface 46. The failure information inputting interface 42 and the maintenance and repair status inputting interface 46 may be a keyboard 48, respectively. Alternatively, a mouse 50 and a pull-down menu module 52 may be jointly used. In this case, the pull-down menu module 52 comprises a plurality of sets of possible failure status information or maintenance and repair status information. The mouse 50 is used to select among the possible failure status information or maintenance and repair status information. In this manner, at least a set of the possible failure status information or the maintenance and repair status information is inputted.

By means of the customer service module, the maintenance staff may adequately understand the reason of maintenance and repair requested given at the service terminal 34 with respect to the wireless communication device through the status displaying interface 44b at the maintenance and repair terminal 36 and the serviceman may fully realize the current status of maintenance and repair of the wireless communication device through the status display interface 44a at the service terminal 34. Therefore, the service quality of maintenance and repair is promoted.

In the above description, the status displaying interface 44a and 44b located in the service terminal 34 and the maintenance and repair terminal 36 respectively may be totally the same or with different GUI configurations. In addition, if the wireless communication device requested to be maintained and repaired is found having been recorded in the database 40 of the customer service module 30, the inputted sets of failure status information and maintenance and repair status information are regarded as new sets of failure status information and maintenance and repair status information respectively or updating the original sets of failure status information and maintenance and repair status information respectively. In addition, although the customer service module 30 is described in the above taking a wireless communication device as an example, the module 30 may service for maintenance and repair of other products. Even, the technical concept of module 30 may be applied to other types of service.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A customer service module providing a service for maintenance and repair for a wireless communication device, comprising:
a failure information inputting interface capable of inputting a status information including a failure status information and an identification serial number associated with the wireless communication device;
a database receiving and storing the status information; and
a status displaying interface searching and displaying the status information stored in the database by inputting the identification serial number.

2. The customer service module as recited in claim 1, wherein the status information further comprises a maintenance and repair information and the customer service module further comprises:
a maintenance and repair inputting interface capable of inputting the identification serial number for abstracting the corresponding status information and further inputting a maintenance and repair status information into the status information, and for displaying the maintenance and repair status information at the status displaying interface by inputting the identification serial number.

3. The customer service module as recited in claim 1, further comprising:
a server, a service terminal and a maintenance and repair terminal, wherein the server is coupled to the service terminal and the maintenance and repair terminal respectively through a network and comprises a database, the service terminal comprising the failure information inputting interface and the maintenance and repair terminal comprises the status displaying interface.

4. The customer service module as recited in claim 1, wherein the identification serial number is selected from the group consisting of a product serial number, and IMEI (International Mobile Equipment Identifier) codes of the wireless communication device.

5. The customer service module as recited in claim 1, wherein the failure information inputting interface further comprises:
a keyboard used for inputting the set of failure status information according to the identification serial number.

6. The customer service module as recited in claim 1, wherein the failure information inputting interface further comprises:
a mouse used for inputting a command;
a pull-down menu module comprising a plurality of sets of failure status information and being selected and inputted by the mouse therefrom.

7. The customer service module as recited in claim 2, wherein the maintenance and repair status inputting interface further comprises:
a keyboard used for inputting the set of maintenance and repair status information according to the identification serial number.

8. The customer service module as recited in claim 2, wherein the maintenance and repair status inputting interface further comprises:
a mouse used for inputting a command;
a pull-down menu module comprising a plurality of sets of maintenance and repair status information and being selected and inputted by the mouse therefrom.

9. A customer service module providing a service for maintenance and repair for a wireless communication device, comprising:
a failure information inputting interface capable of inputting a status information including a failure status information and an identification serial number associated with the wireless communication device;
a maintenance and repair inputting interface capable of inputting the identification serial number for abstracting the corresponding status information and further inputting a maintenance and repair status information into the status information;
a database receiving and storing the status information; and;
a status displaying interface searching and displaying the status information stored in the database by inputting the identification serial number.

10. The customer service module as recited in claim 9, further comprising:
a server, a service terminal and a maintenance and repair terminal, wherein the server is coupled to the service terminal and the maintenance and repair terminal respectively through a network and comprises a database, the service terminal comprises the failure information inputting interface and the maintenance and repair terminal comprises the status displaying interface.

11. The customer service module as recited in claim 9, wherein the identification serial number is selected from the group consisting of a product serial number, and IMEI (International Mobile Equipment Identifier) codes of the wireless communication device.

12. A customer service module providing a service for maintenance and repair for a wireless communication device, comprising:
a server comprising:
a database storing at least a set of status information associated with the wireless communication device and corresponding to an identification serial number of the wireless communication device, wherein the set of status information comprises a set of failure status information;
a service terminal coupling to the server comprising:
a failure information inputting interface capable of inputting the failure status information and the identification serial number to create the status information; and
a maintenance and repair terminal coupling to the server comprising:
a status displaying interface searching and displaying the status information stored in the database by inputting the identification serial number.

13. The customer service module as recited in claim 12, wherein the set of status information further comprises a set of maintenance and repair information and the customer service module further comprises:
a maintenance and repair inputting interface capable of inputting the identification serial number for abstracting the corresponding status information and further inputting a maintenance and repair status information into the status information, and for displaying the maintenance and repair status information at the status displaying interface by inputting the identification serial number.

14. The customer service module as recited in claim 12, wherein the identification serial number is selected from the group consisting of a product serial number, and IMEI (International Mobile Equipment Identifier) codes of the wireless communication device.

15. The customer service module as recited in claim 12, wherein the failure information inputting interface further comprises:
a keyboard used for inputting the set of failure status information according to the identification serial number.

16. The customer service module as recited in claim 12, wherein the failure information inputting interface further comprises:
a mouse used for inputting a command;
a pull-down menu module comprising a plurality of sets of failure status information and being selected and inputted by the mouse therefrom.

17. The customer service module as recited in claim 13, wherein the maintenance and repair status inputting interface further comprises:
a keyboard used for inputting the set of maintenance and repair status information according to the identification serial number.

18. The customer service module as recited in claim 13, wherein the maintenance and repair status inputting interface further comprises:
a mouse used for inputting a command;
a pull-down menu module comprising a plurality of sets of maintenance and repair status information and being selected and inputted by the mouse.
